(19) United States
(12) Patent Application Publication
(10) Pub. No.: US 2026/0202798 A1
(43) Pub. Date: Jul. 16, 2026

(54) PERPETUAL CALENDAR MECHANISM WITH CONCENTRIC CAMS

(71) Applicant: MANUFACTURE D'HORLOGERIE AUDEMARS PIGUET SA, Le Brassus (CH)

(72) Inventor: Xavier GUILLAUME, Le Locle (CH)

(73) Assignee: MANUFACTURE D'HORLOGERIE AUDEMARS PIGUET SA, Le Brassus (CH)

(21) Appl. No.: 18/880,817

(22) PCT Filed: Aug. 7, 2023
(86) PCT No.: PCT/IB2023/057952

§ 371 Date: Jan. 2, 2025

(30) Foreign Application Priority Data
Aug. 16, 2022 (EP) 22190621.7

(51) Int. Cl. G04B 19/253

(52) U.S. Cl. CPC G04B 19/2532

(57) ABSTRACT

The present invention concerns a perpetual calendar mechanism for a watch movement, comprising a set of concentric cams comprising a month cam and a year cam. The mechanism further comprises a lever having a feeler arranged to cooperate with the set of concentric cams, and a star. This star is arranged to be actuated daily directly or indirectly by the lever and to be further actuated on the last day of months of less than 31 days, according to the angular position of the month cam and of the year cam in order to effect a catch-up until the 1st of the following month. The month cam comprises a radial opening so that the feeler of the lever can cooperate with one or the other of the month cam and the year cam depending on the angular position of the month cam.

### TECHNICAL FIELD

The present invention relates to a perpetual calendar mechanism for a watch movement, comprising a month cam and a year cam nested into the month cam in a concentric manner. The invention also relates to a timepiece, in particular a wristwatch, comprising a watch movement equipped with the perpetual calendar mechanism with concentric cams.

### STATE OF THE ART

There are various mechanisms for indicating information relating to the date. These mechanisms are of relatively simple construction for displaying the date without correction, of the annual calendar type capable of controlling the passage of months with 30 and 31 days to the 1st of the following month, and of the perpetual calendar type which includes a mechanical memory, in a way, making it possible not only to control the passage of months with 30 and 31 days to the 1st of the following month, but also the passage of the end of the month of February to the 1st of March taking into account leap years.

Perpetual calendar mechanisms are therefore usually of a complex and cumbersome construction, which can have a significant impact on the size of the watch case incorporating a watch movement equipped with such a mechanism.

By way of example, EP3026504 discloses a perpetual calendar mechanism based on a 48-cam comprising 48 notches, each of which is associated with a month over a period of four consecutive years. This mechanism also includes a lever comprising a feeler tail intended to cooperate with these 48 notches.

EP3734373 discloses another example of a perpetual calendar mechanism. This mechanism comprises a month cam having an eccentric circular cut-out in which a year cam is arranged. A large lever is arranged to come into contact with the profile of one or the other of the month and year cams according to the respective angular position of each cam. As the year cam is eccentric with respect to the month cam, the perpetual calendar mechanism includes a drive system capable not only of rotating the year cam about its axis at a rate of one revolution every four years, but also of driving the year cam together with the month cam about the centre of the latter at a rate of one revolution per year.

This mechanism comprises a drive system which consequently has the disadvantage of being relatively complex in order to impart two distinct movements to the year cam.

An aim of the present invention is therefore to provide a perpetual calendar mechanism that is at least free of the above-mentioned limitations.

More particularly, an aim of the present invention is to provide a compact perpetual calendar mechanism.

Another aim of the present invention is to provide a perpetual calendar mechanism that is simpler to construct, more robust and therefore more reliable.

An additional aim of the present invention is to provide a perpetual calendar mechanism comprising a drive system for the month and year cams that is simplified compared with the above mechanisms.

### BRIEF SUMMARY OF THE INVENTION

These aims are achieved in particular by a perpetual calendar mechanism for a watch movement, comprising a set of concentric cams. This set comprises a month cam arranged to be driven at a rate of one revolution per year, and a year cam arranged to be driven at a rate of one revolution every four years. The month cam comprises a central recess in which the year cam is positioned. The mechanism further comprises a lever with a feeler arranged to cooperate with the set of concentric cams, as well as a star. This star is arranged to be actuated daily directly or indirectly by the lever and to be further actuated on the last day of months of less than 31 days, according to the angular position of the month cam and of the year cam in order to effect a catch-up until it reaches a state corresponding to the 1st day of the following month. The month cam comprises a radial opening so that the feeler of the lever can cooperate with either the month cam or the year cam depending on the angular position of the month cam.

In an embodiment, the thickness of one of the month cam and of the year cam is at least half the thickness of the other of the month cam and of the year cam.

In an embodiment, at least ⅗, preferably at least ⅘ of the thickness of one of the month cam and of the year cam is at the level of the thickness of the other of the month cam and of the year cam.

In an embodiment, the top side of the month cam is substantially coplanar with the top side of the year cam.

In an embodiment, the bottom side of the month cam is substantially coplanar with the bottom side of the year cam.

In an embodiment, the central recess of the month cam comprises a cylindrical wall arranged against at least a part of the profile of the year cam so that said year cam can guide the month cam in rotation.

In an embodiment, the year cam is fixed to a large wheel meshing with at least one wheel arranged to be driven once a month by the star. The month cam is arranged to be driven by a gear train comprising a first wheel fixed to the month cam and mounted coaxially therewith, a second wheel meshing with the first wheel and an intermediate wheel fixed to the second wheel and meshing with the teeth of the large wheel.

In an embodiment, the feeler of the lever is arranged between the first wheel and the large wheel.

In an embodiment, the first wheel and the month cam form together a single piece.

In an embodiment, the large wheel and the year cam form together a single piece.

In an embodiment, the profile of the year cam comprises three radial notches corresponding to the sectors of the month of February of the non-leap years of the cam.

In an embodiment, the mechanism further comprises a 24H wheel arranged to be driven at the rate of one revolution in 24H and a 24H finger fixed to the 24H wheel. The lever comprising for its part a first beak arranged to cooperate with the 24H finger and a second beak arranged to actuate in rotation the star of 31 typically fixed to indications of the days of the month.

In an embodiment, the mechanism further comprises a wheel and a finger fixed to the wheel. The lever comprises a rake in mesh with the wheel in order to engage the finger with the star of 31 each time the lever is actuated by the 24H finger. In this way, the star of 31 can be rotated by one step per day.

Other aspects of the invention relate, on the one hand, to a watch movement equipped with the calendar mechanism with concentric cams according to the invention, and on the other hand to a timepiece, in particular a wristwatch, comprising a watch movement equipped with the calendar mechanism with concentric cams according to the invention.

### BRIEF DESCRIPTION OF THE FIGURES

Examples of embodiments of the invention are given in the description illustrated by the appended figures in which:

FIG. 1 shows a top view of a perpetual calendar mechanism with concentric cams according to an embodiment;

FIG. 2 shows a top view of a lever arranged to cooperate with a set of concentric cams of the mechanism of FIG. 1;

FIG. 3 shows a cross-sectional view of the set of concentric cams and of the feeler of FIG. 2;

FIG. 4 shows an exploded view of the set of concentric cams of FIG. 2;

FIG. 5 shows a perspective view of the month cam from below;

FIG. 6 shows a bottom view of the month cam of FIG. 5;

FIG. 7 shows a top view of the large wheel and of the year cam of the set of concentric cams of FIG. 4;

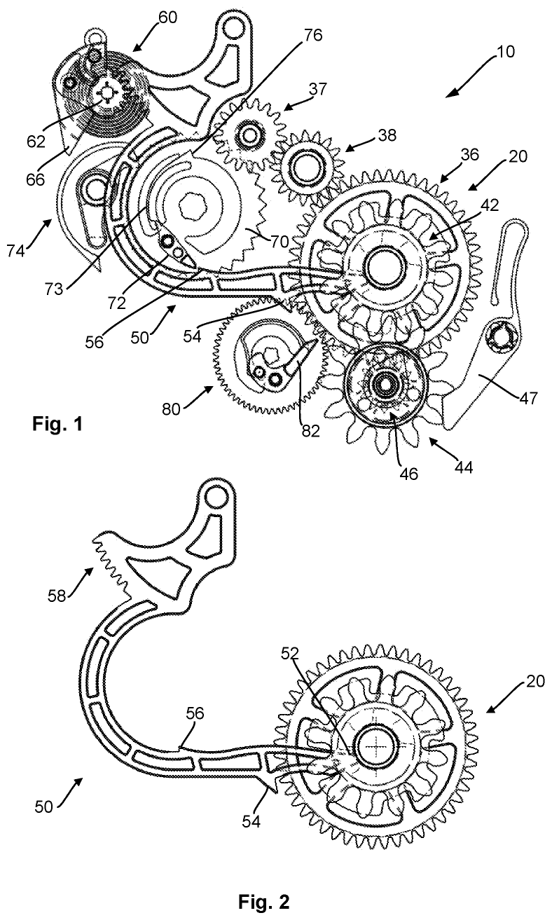

FIGS. 1 and 8a to 8d show top views of an example of an operational sequence of the perpetual calendar mechanism of FIG. 1 during the passage from the last day of the month of February to the first day of the month of March in the course of a non-leap year;

FIGS. 9a and 9b show top views of an example of an operational sequence of the perpetual calendar mechanism of FIG. 1 during the passage from the last day of the month of February to the first day of the month of March in the course of a leap year, and

FIGS. 10a to 10d show top views of an example of an operational sequence of the perpetual calendar mechanism of FIG. 1 during the passage from the 30th day of the month of April to the first day of the month of May.

### EXAMPLES OF EMBODIMENTS OF THE INVENTION

In a preferred embodiment and with reference in particular to FIGS. 1 to 7, the perpetual calendar mechanism 10 comprises a set of concentric cams 20 and a lever 50 arranged to cooperate with the set of concentric cams 20 and to actuate a star of 31-70 according to the information given by the set of concentric cams 20. This set 20 comprises a month cam 22, commonly known as the 12-month cam, and a year cam 30, which are mounted coaxially.

The month cam 22 comprises for this purpose a central recess 28 defined by a cylindrical wall 28a and a radial opening 27 extending from the edge of the cam profile and opening into the central recess 28 as illustrated in particular by FIGS. 5 and 6. The year cam 30 is arranged inside the central recess 28 of the month cam. Preferably, this central recess 28 consists of a through opening formed in the month cam 22. Preferably also, this opening is essentially circular in shape and would allow the year 30 cam to pass through the month cam 22.

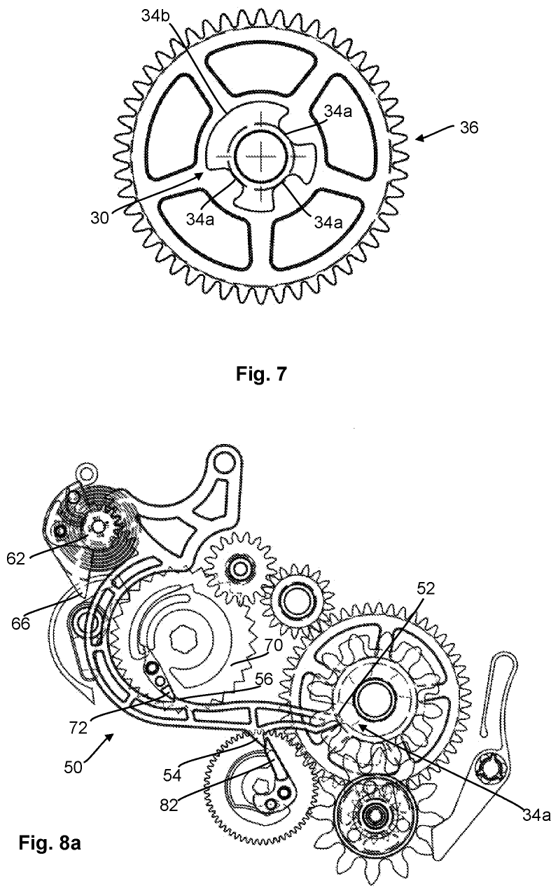

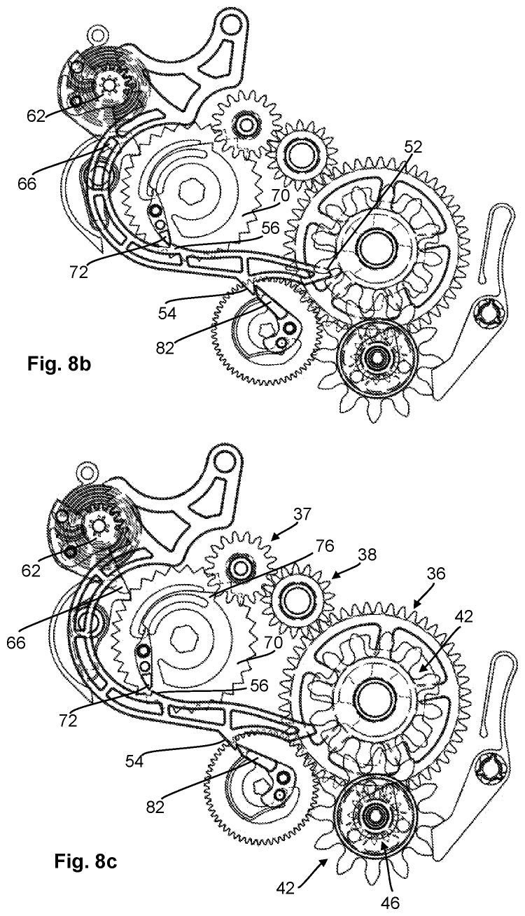

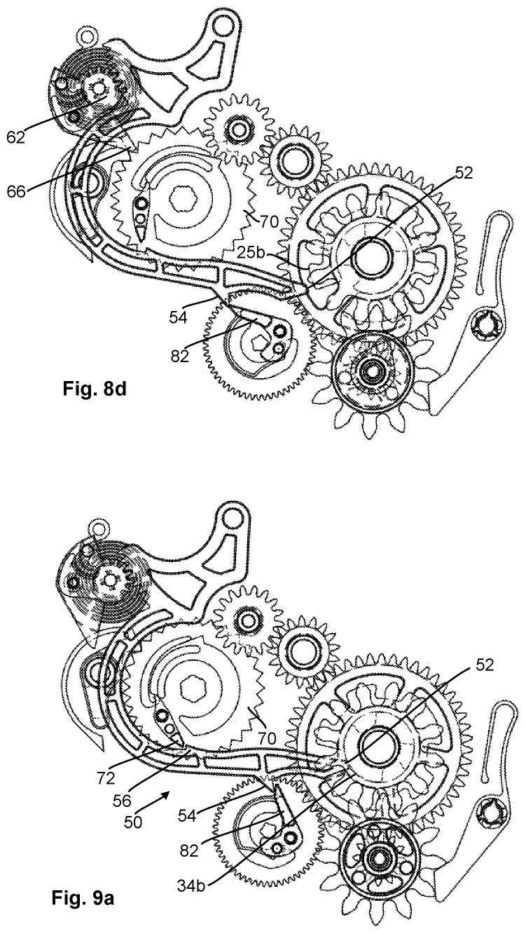

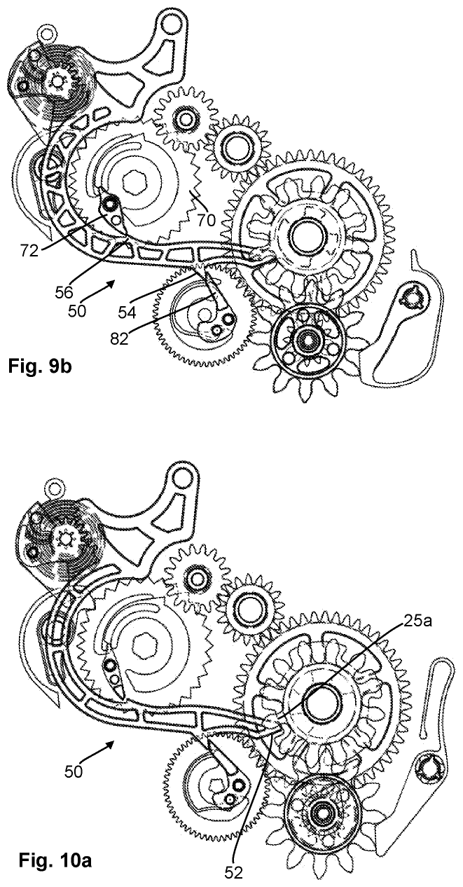

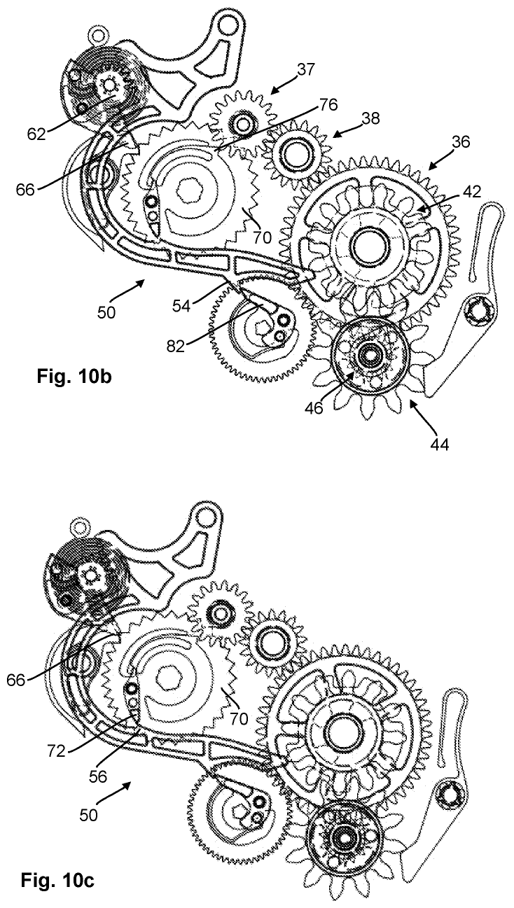

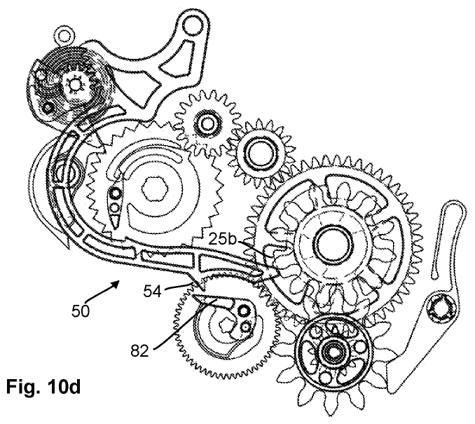

According to FIGS. 6 and 7, the month cam comprises four sectors 25a corresponding to the 30-day months of the year, and seven sectors 25b corresponding to the 31-day months of the year, of which two pairs of sectors, corresponding to the pairs of months July-August and December-January, are each formed of contiguous sectors 25b. The sectors 25a and 25b, as well as the radial opening 27 representing the month of February, are arranged successively so as to represent, in chronological order, the different months of the year.

The radial opening 27 is thus bordered by two sectors 25b corresponding to the months of January and March. Sectors 25a and 25b are typically circular sectors whose distal edges define arcs of circles with the same centre. As described in detail below, the radial opening 27 enables the lever 50 to take information from the year cam in order to adjust the star 70 at the end of the month of February according to whether the year is a non-leap year or a leap year.

With reference to FIG. 7, the profile of the year cam 30 comprises three radial notches 34a spaced apart from each other by 90°. These three notches are used to correct the date display at the end of the month of February of a non-leap year. The profile of the year cam 30 also includes a sector 34b extending between two radial notches 34a which are substantially diametrically opposed. Sector 34b is used to correct the date display at the end of the month of February of a leap year.

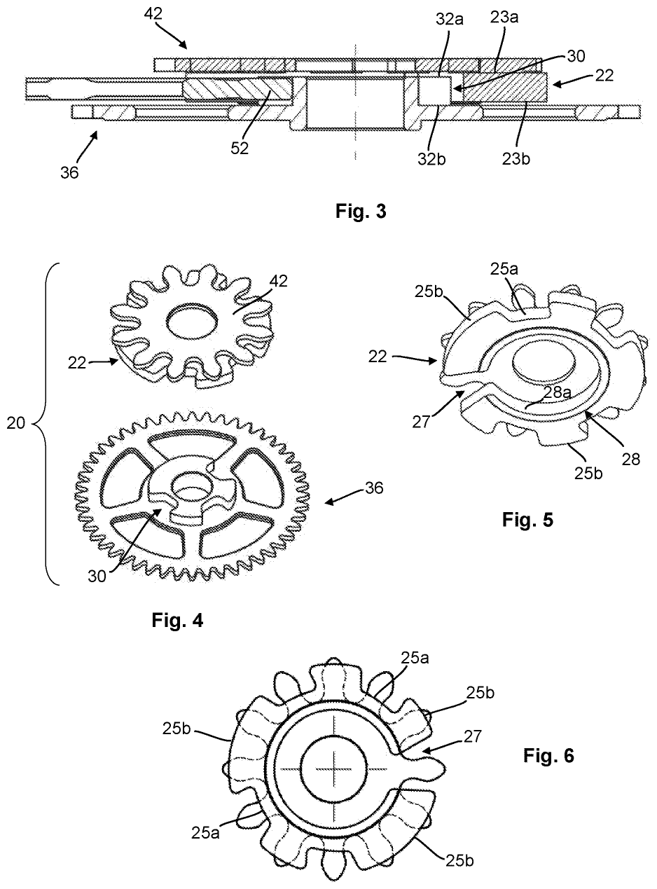

Preferably, the top and bottom sides of the month cam 22 and of the year cam 30 are flat and perpendicular to the common axis of rotation of these cams. Referring to FIG. 3, the top side 23a of the month cam 22 is substantially coplanar with the top side 32a of the year cam 30, i.e. the misalignment between the respective top sides of the two cams does not exceed 20%, preferably 10%, of the thickness of one of the cams. The same applies to the respective bottom sides 23b, 32b of the month cam 22 and of the year cam 30. As a result, the year cam 30 is preferably integrally nested in the month cam 22 with the cam profile of constant diameter lying against the cylindrical wall 28a of the central recess 28 so that the month cam can thus be guided in rotation by the year cam.

The thickness of the month cam may, however, be substantially different from the thickness of the year cam in non-illustrated embodiments. The thickness of the month cam 22 may be much less than the thickness of the year cam 30 and may be, for example, half the thickness of the year cam. The opposite is also possible, i.e. the thickness of the year cam 30 can be much less than the thickness of the month cam 22, for example half the thickness of the latter.

Advantageously, the cylindrical wall 28a defining the central recess 28 of the month cam 22 is arranged against the cam profile of constant diameter of the year cam 30. Preferably, this arrangement is made with just enough clearance so that one of the cams 22, 30 does not drag the other by friction. The year cam can thus be rotated at a rate of one revolution every four years while guiding the rotation of the month cam 22 around its profile at a rate of one revolution per year. The month cam 22 and the year cam 30 therefore remain disconnected and rotate at different speeds.

With reference in particular to FIG. 4, the year cam 30 is connected to a large wheel 36. This wheel is typically in mesh with a gear train preferably comprising a first and a second wheel 37, 38 as shown in FIG. 1. The first wheel 37 is arranged to be driven once a month by a drive finger 76 attached to the star 70. This star is fixed to a display (not shown) comprising the numbers 1 to 31 so that they can appear in succession, for example through a dial aperture. The gear train 37, 38 allows to drive the large wheel 36 by one complete revolution every four years in order to drive the year cam 30 so that the latter also makes one complete revolution every four years.

The large wheel 36 and the year cam 30 are made in a single piece but could also be made separately and fixed one against the other. The month cam 22 is for its part arranged to be driven by a gear train comprising a first wheel 42 connected to the month cam 22 and mounted coaxially therewith, a second wheel 44 in mesh with the first wheel 42 and an intermediate wheel 46 connected to the second wheel 44 and in mesh with the teeth of the large wheel 36. As with the large wheel 36 and the year cam 30, the month cam 22 and the first wheel 42 are made in a single piece but could also be made separately and fixed one against the other.

According to FIG. 1, the second wheel 44 has twelve teeth and cooperates with a jumper spring 47 in order to drive the month cam 22 by the second wheel 44 in rotation at a rate of one jump of 30° (one twelfth of a turn) every month, the jumper spring 47 allowing the jump to be completed. The perpetual calendar mechanism 10 also includes a 24H wheel 80 arranged to be driven at a rate of one revolution per day. A 24H finger 82 is fixed to the 24H wheel 80 to actuate the lever 50 which in turn rotates the wheel 62 in mesh with a rake 58 connected to the lever 50 in order to rotate the star 70 via the finger 66 connected to the wheel 62 so that the star 70 makes one jump each day. In addition, if necessary, an adjustment is made at the end of the month depending on the angular position of the month cam 22 and the year cam 30.

With reference to FIG. 2, the lever 50 comprises for this purpose a feeler 52 arranged to cooperate with the profile of one or the other of the month cam and of the year cam as a function of the respective angular position of each cam. In particular, the feeler 52 is arranged to bear against the profile of one of the aforementioned cams. Being located at different radial distances from the common centre of rotation of the cams 22 and 30, these different profiles allow the variation of the amplitude of the movement of the lever 50, when the latter is actuated by the 24H finger 82.

The feeler 52 is arranged between the first wheel 42 and the large wheel 36 as shown in FIG. 3. According to this illustration, the radial opening 27 of the month cam 22 is positioned facing the feeler 52 so that the feeler can be introduced into this opening to come into contact with the profile of the year cam 30 so as to be able to make the necessary correction at the end of the month of February, taking leap years into account.

The lever 50 further comprises a first beak 54 positioned on the trajectory of the 24H finger 82 and a second beak 56 arranged to actuate the star 70 by means of a catch finger 72 connected to the star 70, the latter cooperating with a jumper spring 74 as shown in FIG. 1. It should be noted that the catch finger 72 is mounted on a leaf spring 73 arranged to bend under the action of the second beak 56 of the lever against the catch finger 72 so that the lever 50 is not blocked by this finger when the feeler 52 falls back against the set of concentric cams 20.

A lever spring 60, for example in the form of a spiral, is fixed to the wheel 62 in order to urge the latter into the angular position illustrated in FIG. 1. This arrangement, comprising in particular the rake 58, the wheel 62 and the lever spring 60, makes it possible to urge the feeler 52 of the lever 50 against the profile of one or the other of the month cam 22 and of the year cam 30 when the lever is at rest. A finger 66 is fixed to the wheel 62 in order to actuate the star 70 by one jump, i.e. one step, each day. It should be noted that FIG. 1 illustrates the state of the mechanism on the 28th day of the month of February in a non-leap year.

As the catch finger 72 is fixed to the star 70, it performs a revolution every month. This finger is disengaged from the trajectory of the second beak 56 of the lever 50 throughout the month so that the lever actuates the star 70 each day solely by means of the finger 66, thus ensuring the transition from one day's indication to the next day's indication. At the end of each month of less than 31 days, the catch finger 72 is positioned on the trajectory of the second beak 56 of the lever 50, as illustrated in particular in FIG. 1.

When the 24H finger actuates the lever 50 again, the latter will drive the star 70 by the action of the second beak 56 on the catch finger 72 as a function of the amplitude of the movement of the lever 50, directly linked to the angular position of each of the month and year cams 22, 30, so that the star 70 can make one or more additional jumps to perform a catch-up during the night from the last day of a month of less than 31 days to the first day of a following month.

The use of a year cam nested in a month cam instead of a conventional 48 cam advantageously makes it possible to have a feeler of larger dimensions and consequently more robust. This makes the perpetual calendar mechanism more reliable and less susceptible to machining defects. It also makes the mechanism easier to assemble and adjust.

The operation of the perpetual calendar mechanism 10 will now be described with reference to FIGS. 1 and 8a to 10d.

FIGS. 1 and 8a to 8d represent an operational sequence at the end of the month of February in a non-leap year. As mentioned above, FIG. 1 illustrates the state of the mechanism on the 28th day of February in a non-leap year. At this point, the lateral edges of a portion of the feeler 52 lie against the edges of the radial opening 27 of the month cam. The distal part of the feeler 52 is inside one of the notches 34a of the year cam 30 (FIG. 7).

FIG. 8a illustrates the mechanism when the 24H finger 82 comes into contact with the first beak 54 of the lever 50 and exerts a thrust on the latter in order to disengage the feeler 52 from the radial notch 34a of the year cam. The second beak 56 of the lever 50 in turn exerts a thrust on the catch finger 72 of the star 31, which initiates the rotation of the latter.

The movement of the second beak 56, illustrated between the representations of FIGS. 8a and 8b, enables the star 70 to be rotated, by means of the catch finger 72, so that this star performs three successive jumps. The amplitude of the movement of the lever 50 is therefore at its maximum during this period. As the lever 50 moves, its rake rotates the wheel 62, which progressively pivots the finger 66 until it moves the star 70 by one step, as shown in FIGS. 8c and 8d. Thus, on the night of the 28th of February to the 1st of March of a non-leap year, the second beak 56 of the lever 50 activates the star 70 so that it makes three successive jumps, then the finger 66 activates the star so that it makes an additional jump.

It should be noted with reference to FIG. 8c that the actuation of the star 70 at the end of this month enables the first wheel 37 to be driven via the drive finger 76. The first wheel, via the second wheel 38, drives the large wheel 36 so that the latter rotates through one forty-eighth of a revolution. This rotation also drives the year cam 30 through one forty-eighth of a revolution and the month cam 22 through one twelfth of a revolution via the gear train comprising the first and second wheels 42, 44 and the intermediate wheel 46. A sector 25b of the month cam corresponding to a month of 31 days, in this case the month of March, is thus in the trajectory of the feeler 52 of the lever, as can be seen in FIG. 8d. Once the 24H finger 82 is disengaged from the first beak 54 of the lever, the feeler 52 is brought back against the sector 25b under the action of the spiral spring 60.

From 1st of March, the catch finger 72 is disengaged from the trajectory of the beak 56 of the lever 50 throughout the month so that the latter actuates the star 70 each day solely by means of the finger 66, thus ensuring the passage from an indication of one day to an indication of the following day. The contact of the feeler 52 of the lever against the sector 25b of the month cam enables the lever 50 to be positioned so that the second beak 56 is disengaged from the trajectory of the catch finger 72, in particular at the end of the month during its passage through the period 30-31 March. No correction is therefore made for this month. The same applies to all months which, like March, have 31 days.

FIGS. 9a and 9b illustrate an operational sequence at the end of the month of February of a leap year. FIG. 9 a shows the mechanism on the 29th day. The feeler 52 of the lever 50 is arranged at this point against a sector 34b of the profile of the year cam. During the night from the 29th to 1st of March, the 24H finger 82 exerts a thrust on the first beak 54 of the lever 50, driving the latter until the second beak 56 in turn exerts a thrust on the catch finger 72 of the star 70 (FIG. 9b) so that the latter makes two successive jumps. The finger 66 then actuates the star 70 as described above, which makes an additional jump in order to change the indication from the 29th to the 1st of March.

FIGS. 10a to 10d show an operational sequence at the end of the month of April. FIG. 10a shows the mechanism on the 30th day of the month of April. The feeler 52 of the lever 50 is arranged at this point against a sector 25a of the profile of the month cam. The 24H finger 82 exerts a thrust on the first beak 54 of the lever 50 as shown in FIG. 10b, then the second beak 56 of the lever drives the star 70 via the catch finger 72 as shown in FIG. 10c, so that the star makes a jump followed by an additional jump under the action of the finger 66, which is pivoted by the action of the rake of the lever on the wheel 62.

It can be seen from FIG. 10b that the actuation of the star 70 at the end of this month enables the first wheel 37 to be driven via the drive finger 76. The gear train 37, 38 connecting the star 70 to the large wheel 36, as well as the gear train 44, 46 connecting the large wheel 36 to the first wheel 42, as described above, enable the month cam to be driven by a twelfth of a revolution. A sector 25b of the month cam corresponding to a month of 31 days, in this case the month of May, is thus on the trajectory of the feeler 52 of the lever.

According to FIG. 10d, once the 24H finger 82 is disengaged from the first beak 54 of the lever, the feeler 52 is brought against the sector 25b under the action of the spiral spring 60.

The sequence of operation described above with reference to the month of April remains identical for the other months of the year which, like the month of April, also have 30 days.

Various modifications can be made to the calendar mechanism which has just been described without departing from the invention as defined by the claims. For example, the lever 50 could be shaped to actuate the star of 31 directly each day so that the latter can, in particular, make a single jump independently of the amplitude of movement of the lever, which would make it possible, for example, to eliminate the need for the finger 66. According to another variant, the lever could be replaced by a conventional large lever comprising a large click cooperating with a cam 31 fixed to the star of 31 in place of the catch finger.

### LIST OF REFERENCE SIGNS

Perpetual calendar mechanism 10
Set of concentric cams 20
Month cam 22
Top side 23a
Bottom side 23b
30-day months sectors 25a
31-day months sectors 25b
Radial opening 27
Central recess 28
Cylindrical wall 28a
Year cam 30
Top side 32a
Bottom side 32b
Radial notches 34a
Sector 34b
Large wheel 36
Gear train
First and second wheels 42, 44
Intermediate wheel 46
Jumper spring 47
Gear train
First and second wheels 37, 38
Lever 50
Feeler 52
First beak 54
Second beak 56
Rack 58
Lever spring 60 (e.g. spiral)
Wheel 62
Finger 66
Star of 31-70
Catch finger 72
Leaf spring 73
Jumper spring 74
Drive finger 76
24H wheel 80
24H finger 82

1. Perpetual calendar mechanism for a watch movement, comprising:
a set of concentric cams comprising a month cam, which comprises a central recess and is arranged to be driven at the rate of one revolution per year, and a year cam, which is positioned in the central recess of the month cam and is arranged to be driven at the rate of one revolution every four years,
a lever comprising a feeler arranged to cooperate with the set of concentric cams, and
a star arranged to be actuated daily directly or indirectly by the lever and to be further actuated on the last day of months of less than 31 days, according to the angular position of the month cam and of the year cam in order to effect a catch-up until it reaches a state corresponding to the 1st day of the following month,
wherein the month cam comprises a radial opening so that the feeler of the lever can cooperate with one or the other of the month cam and the year cam depending on the angular position of the month cam.

2. The mechanism of claim 1, wherein the thickness of one of the month cam and of the year cam is at least half the thickness of the other of the month cam and of the year cam.

3. The mechanism of claim 1, wherein at least ⅗, preferably at least ⅘ of the thickness of one of the month cam and of the year cam is at the level of the thickness of the other of the month cam and of the year cam.

4. The mechanism of claim 1, wherein the top side of the month cam is substantially coplanar with the top side of the year cam.

5. The mechanism of claim 1, wherein the bottom side of the month cam is substantially coplanar with the bottom side of the year cam.

6. The mechanism of claim 1, wherein the central recess of the month cam comprises a cylindrical wall arranged against at least a part of the profile of the year cam so that said year cam can guide the month cam in rotation.

7. The mechanism of claim 1, wherein the year cam is fixed to a large wheel meshing with at least one wheel arranged to be driven once a month by the star, and wherein the month cam is arranged to be driven by a gear train comprising a first wheel fixed to the month cam and mounted coaxially therewith, a second wheel meshing with the first wheel and an intermediate wheel fixed to the second wheel and meshing with the teeth of the large wheel.

8. The mechanism of claim 7, wherein the feeler of the lever is arranged between the first wheel and the large wheel.

9. The mechanism of claim 7, wherein the first wheel and the month cam form together a single piece.

10. The mechanism of claim 7, wherein the large wheel and the year cam form together a single piece.

11. The mechanism of claim 1, wherein the profile of the year cam comprises three radial notches corresponding to the sectors of the non-leap years of the cam.

12. The mechanism of claim 1, further comprising a 24H wheel arranged to be driven at the rate of one revolution in 24H and a 24H finger fixed to the 24H wheel, the lever comprising a first beak arranged to cooperate with the 24H finger and a second beak arranged to actuate the star in rotation via a catch finger fixed to the said star.

13. The mechanism of claim 12, further comprising a wheel and a finger fixed to the wheel, the lever comprising a rake in mesh with the wheel in order to engage the finger with said star each time the lever is actuated by the 24H finger.

14. Watch movement comprising the mechanism of claim 1.

15. Timepiece, in particular a wristwatch, comprising the watch movement of claim 14.
